(19) United States
(12) Patent Application Publication
(10) Pub. No.: US 2026/0251456 A1
(43) Pub. Date: Aug. 27, 2026

(54) VEHICLE SYSTEM AND METHOD

(71) Applicant: Transportation IP Holdings, LLC, Norwalk, CT (US)

(72) Inventors: Keith Edward Smith, Cedar Rapids, IA (US); Carlos Ulisses Menezes, Haslet, TX (US)

(73) Assignee: Transportation IP Holdings, LLC, Norwalk, CT (US)

(21) Appl. No.: 19/063,863

(22) Filed: Feb. 26, 2025

(51) Int. Cl. G01C 21/20

(52) U.S. Cl. CPC G01C 21/20

(57) ABSTRACT

A system and method are disclosed. An example system may be capable of managing movement of vehicles within a vehicular travel area and includes a control circuit. The control circuit may receive a request for a movement authority to maneuver a vehicle within a maneuvering zone. The maneuvering zone may define a portion of a vehicular travel area and includes two or more potential movement segments. The control circuit may grant the vehicle the movement authority to maneuver within the maneuvering zone.

### BACKGROUND

### Technical Field

Various aspects of the present disclosure relate to managing vehicle movement.

### Discussion of Art

Dispatch control systems may be utilized to manage movement of vehicles within a specified territory, e.g., a dispatch control territory. The dispatch control system may control movement of vehicles within a specific vehicular travel area in the dispatch control territory. The vehicular travel area may include multiple different movement segments that vehicles can travel along. The dispatch control system may communicate with the vehicles that are within the vehicular travel area to control which of the vehicles are allowed on particular movement segments within the vehicular travel area at a given time.

As an example, dispatch control systems are sometimes utilized in the rail industry to manage movement of locomotives within a vehicular travel area, such as a rail yard. The rail yard may include multiple different movement segments, such as segments of track, that the locomotives and rail cars can travel along. A dispatch operator may utilize the dispatch control system to communicate with onboard operators of the locomotives via onboard control systems and control which of the locomotives are allowed on particular segments of track. Dispatch control systems may be utilized to manage vehicle movement in other industries such as, for example, the maritime transport industry (e.g., to manage port operations), the aviation industry (e.g., to manage ground control operations, to manage air traffic), and the trucking industry (e.g., to manage freight terminal operations).

Managing vehicle movement within a vehicular travel area can require frequent communications between the operator at the dispatch control system and the onboard operators of the vehicles. For example, in the rail industry, a rail yard may include hundreds of different segments of track that are used for storing, sorting, loading, and unloading rail cars. A locomotive operator may be tasked with forming a train by moving the locomotive to and coupling the locomotive with rail cars that are sorted across different locations within the rail yard. To do so, the locomotive operator many need to maneuver the locomotive across multiple different segments of track, sometimes in a repetitive manner. Each time the locomotive needs to move from one segment of track to another, the locomotive operator may need to request from the operator at the dispatch control system a movement authority to travel along the next segment of track. In some cases, an electronic interlock can prevent the locomotive from moving to the next segment of track unless the movement authority is received. In some cases, the movement authority is needed to actuate a switch or a signal to enable the locomotive to move to the next segment of track. Therefore, to form the train, the locomotive operator may need to repetitively request movement authorities from the operator at the dispatch control system.

It may be desirable to have a system and method for managing vehicle movement within a vehicular travel area that differs from those that are currently available.

### BRIEF DESCRIPTION

In one or more embodiments, a system is provided. The system includes a control circuit. The control circuit may receive a request for a movement authority to maneuver a vehicle within a maneuvering zone. The maneuvering zone may define a portion of a vehicular travel area and includes two or more potential movement segments. The control circuit may grant the vehicle the movement authority to maneuver within the maneuvering zone.

In one or more embodiments, a system is provided. The system includes a control circuit. The control circuit may request a movement authority to maneuver a vehicle within a maneuvering zone. The control circuit may receive the movement authority from the system and move the vehicle along a selected route within the maneuvering zone.

In one or more embodiments, a method is provided. The method may include receiving a request from a vehicle control system to permit a vehicle to maneuver within a maneuvering zone. The maneuvering zone is defined by at least two separate movement segments of a vehicular travel area. The method may further include granting a movement authority permitting the vehicle for unrestricted maneuvering along any of the separate movement segments that define the maneuvering zone.

### BRIEF DESCRIPTION OF THE DRAWINGS

Reference is made to the accompanying drawings in which similar components are indicated using the same reference numbers, and in which:

FIG. 1 illustrates a schematic diagram of a system for managing vehicle movement within a vehicular travel area, according to one embodiment.

FIG. 2 is a schematic illustration of a vehicle control system, according to one embodiment.

FIG. 3 is a schematic illustration of a dispatch control system, according to one embodiment.

FIG. 4 is a flow diagram of a method for managing vehicle movement within a vehicular travel area, according to one embodiment.

### DETAILED DESCRIPTION

Various aspects of the present disclosure relate to a system capable of managing vehicle movement within a vehicular travel area. To manage vehicle movement, the system may grant to a vehicle a movement authority that allows the vehicle to maneuver within a portion of the vehicle travel area defining a maneuvering zone. The maneuvering authority may enable or otherwise allow the vehicle to move along different potential movement segments within the maneuvering zone. The system may also prevent other vehicles from traveling within the maneuvering zone based at least in part on granting the movement authority. The system disclosed herein may therefore provide an alternative to communication intensive approaches to managing vehicle movement within a vehicle travel area that can require review and approval from a dispatcher or the issuance of a separate movement authority any time a vehicle requests to move between different potential movement segments.

In one embodiment, a system for managing vehicle movement may include a dispatch control system. The dispatch control system may include or otherwise be defined by a control circuit. The vehicular travel area may correspond to a dispatch control territory managed by the dispatch control system. The dispatch control system may communicate with one or more vehicle control systems of vehicles that are within the vehicular travel area or are proximate to the vehicular travel area. Each of the vehicle control systems may include or otherwise be defined by a control circuit.

The dispatch control system may receive a request from a vehicle control system for a movement authority to maneuver a vehicle within a maneuvering zone. The maneuvering zone may define a portion of the vehicular travel area and may include two or more potential movement segments that are traversable by the vehicle. For example, the vehicular travel area may include a plurality of different movement segments. A subset of the movement segments may define the maneuvering zone. Moving the vehicle between movement segments may involve moving the vehicle out of one movement segment and into another movement segment. Moving the vehicle between movement segments may involve adjusting a switch to operably connect and enable vehicle travel from one movement segment to another movement segment. Control signals may be positioned within the vehicular travel area to indicate whether a vehicle has movement authority or is otherwise enabled to travel from one movement segment to another movement segment.

In one embodiment, the dispatch control system may determine a list of available routes within the vehicular travel area along which it would allow the vehicle to travel. The maneuvering zone may be defined based at least in part on the list of available routes within the vehicular travel area. The dispatch control system may determine the list of available routes based at least in part on position and movement data of other vehicles in the vehicular travel area. The position and movement data may include planned routes of the other vehicles in the vehicular travel area. The list of available routes may include routes that do not conflict with the planned routes of the other vehicles. The dispatch control system may transmit the list of available routes to the vehicle control system.

The request from the vehicle control system a vehicle control system for the movement authority may define the requested maneuvering zone based at least in part on identifying potential routes from the list of available routes. For example, an operator of the vehicle may provide an input to the vehicle control system selecting the potential routes from the list of available routes to define a maneuvering zone and request a movement authority to maneuver within the defined maneuvering zone. Additionally, or alternatively, the dispatch control system may receive the request for the movement authority to maneuver a vehicle within a maneuvering zone, determine the list of available routes within the maneuvering zone, and transmit the list of available routes within the maneuvering zone to the vehicle control system.

Routes within the list of available routes can correspond to or otherwise include one or more of the potential movement segments within the maneuvering zone. For example, a first route of the available routes may include a first potential movement segment (e.g., a plurality of first potential movement segments) and a second route of the available routes may include a second potential movement segment (e.g., a plurality of second potential movement segments). The dispatch control system may exclude a route from the list of available routes if traveling along the route requires movement along a movement segment that is outside of the maneuvering zone. Additionally, or alternatively, the dispatch control system may determine the portion of the vehicular travel area that defines the maneuvering zone based at least in part on available potential movement segments.

The dispatch control system may grant the vehicle the movement authority to maneuver within the maneuvering zone. The dispatch control system may transmit the movement authority to the vehicle control system. The movement authority can allow the corresponding vehicle to travel between the potential movement segments within the maneuvering zone, for example, without requiring additional requests and movement authority issuances each time the vehicle moves from one movement segment to another. Accordingly, the system for managing vehicle movement provided herein may provide an alternative approach to systems that require the issuance of a separate movement authority each time a vehicle requests to move from one movement segment of a vehicular travel area to another. The vehicle control system can move the vehicle along a selected route of the available routes within the maneuvering zone based at least in part receiving the movement authority.

Other vehicles besides the vehicle receiving the movement authority to maneuver within the maneuvering zone (the authorized vehicle) may be within or have a planned route that intersects the vehicular travel area. The dispatch control system can assess position and movement data corresponding to other vehicles. The dispatch control system may withhold access of the other vehicles from the maneuvering zone based at least in part on granting the authorized vehicle the movement authority to maneuver within the maneuvering zone.

The dispatch control system may detect a conflict related to maneuvering the authorized vehicle within the maneuvering zone and a planned movement of at least one of the other vehicles, for example, based at least in part on assessing the position and movement data corresponding to the other vehicles. The dispatch control system may execute one or more actions based at least in part on detecting the conflict. The one or more actions can include revoking the movement authority from the authorized vehicle, preventing or modifying the planned movement of the least one of the other vehicles to avoid the conflict, and/or modifying the maneuvering zone to define a different portion of the vehicular travel area to avoid the conflict. Modifying the maneuvering zone to define a different portion of the vehicular travel area to avoid the conflict may include removing one or more potential movement segments from the maneuvering zone. The removed movement segment(s) may overlap with the planned movement of at least one of the other vehicles.

The dispatch control system, the vehicle control system, or both the dispatch control system and the vehicle control system may adjust a control device to enable the authorized vehicle to travel along a selected route from the available routes defining the maneuvering zone. Additionally, adjusting the control device may prevent other vehicles from traveling within the maneuvering zone. The adjustment of the control device may be based at least in part on granting the movement authority to the authorized vehicle.

In some embodiments, the control device may be a positivecontrol device that restricts or prevents vehicle movement unless the positive control device receives a movement authority. The vehicle control system of the authorized vehicle may comprise such a positive control device. The movement authority for maneuvering the authorized vehicle within the maneuvering zone can cause the positive control device to not prevent movement of the authorized vehicle within the maneuvering zone unless a condition changes. For example, with the movement authority for maneuvering the authorized vehicle within the maneuvering zone, the positive control device may not prevent or restrict movement of the authorized vehicle within the maneuvering zone unless the positive control device receives an alarm, a manual override, an indication that the authorized vehicle has violated a movement restriction (e.g., a speed restriction), and/or an indication that an object or another vehicle has entered the maneuvering zone. Any of the vehicle control systems of other vehicles within the vehicular travel area can comprise a positive control device. Granting the movement authority to the authorized vehicle may cause the positive control devices of the other vehicles to prevent the other vehicles from traveling within the maneuvering zone. A suitable positive control device may include a positive train control (PTC) device.

In some embodiments, the control device may include a switch that is actuatable to operably connect and disconnect movement segments to enable and disable travel therebetween. The switch may be actuatable to operably connect movement segments within the maneuvering zone to enable the authorized vehicle to travel between different potential movement segments and available routes. The switch may be actuatable to disconnect movement segments to prevent other vehicles from traveling inside the maneuvering zone. Additionally, or alternatively, the control device may include a signal for indicating whether or not vehicle travel is authorized move between particular movement segments. For example, a suitable vehicle may include a rail vehicle, and the vehicular travel area may include plurality of tracks traversable by the rail vehicle. The switch may be a track switch that is actuatable to operably connect and disconnect different segments of track. The signal may be a track signal indicating whether a vehicle travel is authorized between particular track segments.

In one embodiment, the switch may be automated and may be controlled by the dispatch control system. For example, a vehicle control system may receive a movement authority to maneuver within a maneuvering zone and may receive a list of available routes within the maneuvering zone. The vehicle control system may receive an operator input selecting a route from the list of available routes. The dispatch control system may automatically actuate one or more than one switch to enable the vehicle to travel along the selected route based at least in part on the operator input.

In one embodiment, the switch may be automated and the control of the switch may be transferred to the vehicle control system based at least in part on the grant of the movement authority. For example, a vehicle control system may receive a movement authority to maneuver within a maneuvering zone. The vehicle control system may receive an operator input that causes actuation of the switch. Thus, an onboard operator of the authorized vehicle may be able to control the switch as desired based at least in part on the grant of the movement authority. In other embodiments, the switch may require manual actuation.

The dispatch control system may modify the maneuvering zone to define a different portion of the vehicular travel area based at least in part on a selected route for travel by the authorized vehicle. For example, the vehicle control system may indicate to the dispatch control system that the vehicle system plans to travel along only a subset of the available routes within the maneuvering zone. The dispatch control system may modify the maneuvering zone to exclude at least some of the potential movement segments that do not correspond to the subset of the available routes that the vehicle control system indicated for planned travel.

The vehicle control system may transmit an indication to the dispatch control system that the maneuvering authority is no longer requested, or that the desired vehicle movement is complete. The dispatch control system may revoke the movement authority based at least in part on receiving the indication from the vehicle system that the movement authority is no longer requested, or the desired vehicle movement is complete.

Embodiments may be described in connection with a rail vehicle system, such as a locomotive or switcher, or other types of vehicle systems, such as automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

Movement of the vehicle may include propelling the vehicle forward or backward along a movement segment, as well as slowing or stopping the vehicle. Movement further may include turning left or right, and increasing or decreasing elevation or depth to transition to between movement segments. Movement may include determining or setting a vehicle speed, changing a vehicle speed, matching speeds between vehicles. Indirectly, movement of the vehicle may include ramping up (or down) power sources; and this may include energizing electrical circuits or buses, setting fuel flow rates, setting engine RPM rates, and the like.

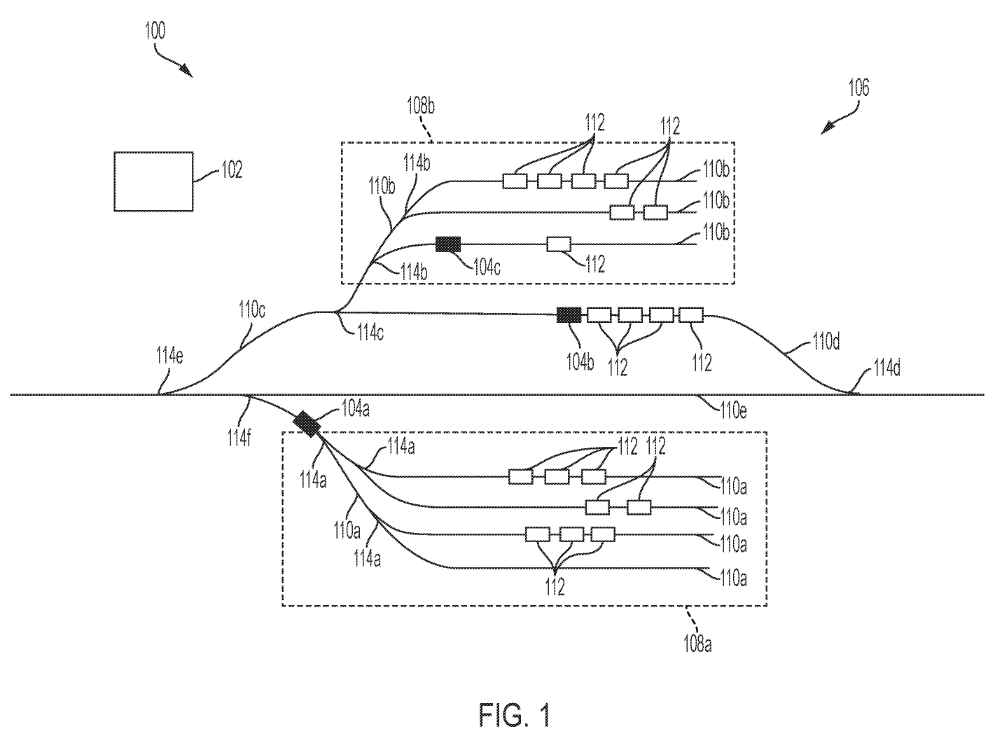

FIG. 1 illustrates one embodiment of a system 100 for managing vehicle movement within a vehicular travel area 106. Any aspects of the system of FIG. 1 can be combined with any of the other system embodiments described herein and vice vera.

The system includes a dispatch control system 102 and a plurality of vehicles including a first vehicle 104a, a second vehicle 104b, and a third vehicle 104c. Each vehicle may include a vehicle control system for controlling movement of the vehicle. The vehicle control system of each vehicle is communicably coupled with the dispatch control system.

The vehicular travel area is a dispatch control territory controlled by the dispatch control system. The vehicular travel area includes a plurality of movement segments including first movement segments 110a, second movement segments 110b, a third movement segment 110c, a fourth movement segment 110d, and a fifth movement segment 110e. The first vehicle, the second vehicle, and the third vehicle are capable of moving along the movement segments.

The vehicular travel area includes a plurality of switches including first switches 114a, second switches 114b, a third switch 114c, a fourth switch 114d, a fifth switch 114e, and a sixth switch 114f. The switches may require manual actuation, or the switches may be powered and actuatable based on receiving a signal from the dispatch control system, or some of the switches may be manually actuatable and some of the switches may be automatically actuatable.

The first vehicle, the second vehicle, and the third vehicle are couplable with non-propulsion generating vehicles 112 to form a vehicle system. For example, FIG. 1 illustrates the second vehicle coupled with a plurality of non-propulsion generating vehicles. Suitable first, second, and third vehicles can include a locomotives and suitable non-propulsion generating vehicles can include rail cars.

It may be desirable to move the first vehicle within the vehicular travel area along the first movement segments so that the first vehicle can travel proximate to and couple with more than one of the non-propulsion generating vehicles stored on the first movement segments. Actuation of at least one of the first switches may require for the first vehicle to move between the first movement segments and couple with the desired non-propulsion generating vehicles.

The vehicle control system of the first vehicle may request a movement authority from the dispatch control system that allows the first vehicle to maneuver within a first maneuvering zone 108a. For example, an operator of the vehicle control system may select the first movement segments (or first routes corresponding to the first movement segments) from a list of available movement segments (or a list of available routes) and request a movement authority to maneuver across those segments.

The dispatch control system may analyze position and movement data corresponding to the other vehicles (e.g., the second vehicle and the third vehicle) to determine whether a conflict exists related to granting the requested movement authority. For example, the dispatch control system may determine if any of the other vehicles are at positioned on at least one of the first movement segments or have a planned movement that includes at least one of the first movement segments.

The dispatch control system may determine that no conflict exists related to granting the requested movement authority. The dispatch control system may define the first maneuvering zone corresponding to the first movement segments and may grant the first vehicle the movement authority to maneuver within the first maneuvering zone.

The first vehicle may move along and between the first movement segments to couple with the desired non-propulsion generating vehicles based at least in part on receiving the movement authority to maneuver within the first maneuvering zone. Granting the movement authority to the first vehicle may cause adjustment of a control device. For example, the vehicle control system of the first vehicle may include a positive control device. Granting the movement authority may cause the positive control device to not prevent movement of the first vehicle within the first maneuvering zone. As another example, as noted above, the switches may be powered and actuatable based on receiving a signal from the dispatch control system. Granting the movement authority may enable the vehicle control system of the first vehicle to control actuation of the first switches.

Dispatch control system may prevent other vehicles (e.g. the second vehicle and the third vehicle) from entering the first maneuvering zone based at least in part on granting the movement authority to the first vehicle. For example, the vehicle control system of the second vehicle and the third vehicle may each include a positive control device. Granting the movement authority to the first vehicle may cause the positive control device of the second vehicle and the third vehicle to prevent the second vehicle and the third vehicle from traveling into the first maneuvering zone. As another example, granting the movement authority may cause the sixth switch to operably decouple the fifth movement segment from the first movement segments thereby preventing the other vehicles from moving from the fifth movement segment to the first movement segments and into the first maneuvering zone.

Accordingly, unlike various alternate systems that may require that the vehicle control system of the first vehicle request a separate movement authority each time one of the first switches needs to be actuated so that the first vehicle can travel from one of the first movement segments to another one of the first movement segments, the dispatch control system may issue a movement authority that permits and enables the first vehicle to maneuver anywhere within the first maneuvering zone and between any of the first movement segments.

It may be desirable to move the third vehicle within the vehicular travel area along the second movement segments so that the third vehicle can travel proximate to and couple with more than one of the non-propulsion generating vehicles stored on the second movement segments while the movement authority (the first movement authority) is active and granted to the first vehicle.

The vehicle control system of the third vehicle may request a second movement authority from the dispatch control system that allows the third vehicle to maneuver within a second maneuvering zone 108b in a similar manner to which the vehicle control system of the first vehicle requested the first movement authority, except identifying the second movement segments for maneuvering. The dispatch control system may analyze position and movement data corresponding to the other vehicles (e.g., the first vehicle and the second vehicle) to determine whether a conflict exists related to granting the requested second movement authority. The dispatch control system may grant the second movement authority for the third vehicle to maneuver within the second maneuvering zone along the second segments while the first maneuvering authority for the first vehicle is active.

In one embodiment, the same movement authority may be granted to multiple vehicles. For example, the second vehicle may request a movement authority for the second maneuvering zone. The third vehicle may be positioned in the third maneuvering zone but may, for example, be idle. The second vehicle may receive the requested movement authority for the second maneuvering zone. The second vehicle may couple with the third vehicle in the second maneuvering zone. Coupling the second vehicle with the third vehicle may cause the movement authority for the second maneuvering zone granted to the second vehicle to also be granted to the third vehicle.

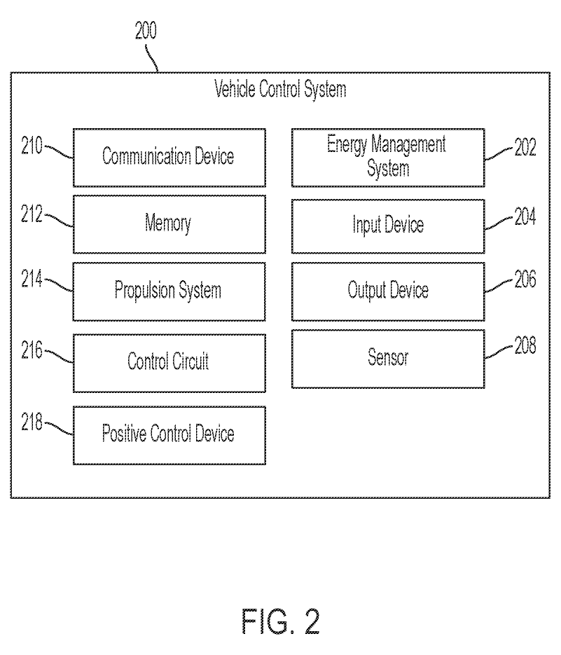

FIG. 2 is a schematic illustration of one embodiment of a vehicle control system 200. The vehicle control system can control the movement of a vehicle. The vehicle control system can be controlled manually (e.g., by a human operator onboard the vehicle system) and/or autonomously with an energy management system (EMS) 202. For example, an operator onboard of the vehicle system may manually control movement of the vehicle system by manually controlling the hardware, controllers, devices, or the like of the vehicle control system. Additionally, or alternatively, the EMS may autonomously control movement of the vehicle system (e.g., without input by an operator onboard the vehicle system) by electrically communicating directions and/or commands to the systems and devices associated with the vehicle control system. A suitable EMS may be Trip Optimizer system, commercially available from Wabtec Corporation.

The vehicle control system may be connected with an input device 204 and an output device 206. A suitable vehicle control system may receive manual input from an onboard operator of the vehicle system through the input device. The input device can include one or more than one device such as a touchscreen, keyboard, electronic mouse, microphone, throttle, pedal, button, and/or other input devices. For example, the vehicle control system can receive manual inputs for changing a tractive effort, braking effort, speed, power output, and the like, from the input device.

The vehicle control system may present information to an operator of the vehicle using the output device. The output device may include one or more than one device such as a display screen (e.g., touchscreen or other screen), a speaker, a printer, and/or other output devices. For example, the vehicle control system may present the status(es) of the vehicle and non-propulsion generating vehicles coupled thereto, contents of one or more command messages, available routes within a maneuvering area, movement authority status, or the like. The output device may provide a notification signal to the operator of the vehicle that automatically informs (e.g., notifies) the operator that a movement authority has been received or needs to be requested. Optionally, the output device may present instructions to an operator onboard the vehicle from the vehicle control system that instruct the operator how to manually control the movement of the vehicle. For example, the output device may instruct a throttle notch setting, speed setting, brake setting, power draw setting, power return setting, propulsion source setting, or the like, to the operator of the vehicle system for the operator onboard the vehicle to manually control the movement of the vehicle.

The vehicle control system may include or otherwise be coupled to a propulsion system 214 of a vehicle. The propulsion system may provide tractive effort and/or braking effort of the vehicle. The propulsion system can include one or more of engines, motors, alternators, generators, brakes, batteries, turbines, fuel cells, fuel systems, and the like. Components of the propulsion system may operate to propel the vehicle responsive to the vehicle control system. For example, the vehicle control system can direct operations of the propulsion system by the vehicle control system generating control signals autonomously or based at least in part on manual input by an onboard operator or a remote operator.

The vehicle control system includes a control circuit 216 that may receive signals from the input device and/or the EMS and based at least in part on the signals from the input device and/or the EMS, the control circuit can control settings of the propulsion system to control movement of the vehicle system. The vehicle control system further may include a memory 212 and a communication device 210. The communication device may include or represent hardware and/or software that is used to communicate with the dispatch control system via a network. For example, the communication device may include a transceiver and associated circuitry for wirelessly communicating linking messages, requests, command messages, reply messages, repeat messages, or the like. Optionally, the communication device includes circuitry for communicating messages over a wired connection, such as an electric multiple unit (eMU) line of a vehicle system, catenary or third rail for electrically powered vehicles, or another conductive pathway between or among the non-propulsion vehicles coupled to the vehicle.

The vehicle control system may include or otherwise be connected with one or more than one sensor 208 and can include software and/or circuitry that include and/or are connected with one or more processors. The sensor can be an object detection sensor. The sensor can obtain sensor data that is indicative of an area outside of the vehicle. For example, the sensor may obtain sensor data in an area in front of the vehicle relative to a direction of travel of the vehicle, in an area behind the vehicle relative to a direction of travel of the vehicle, or the like. The sensor may include a camera that obtains still and/or motion visual data of an area of the route in the direction of travel of the vehicle and/or in a direction opposite the direction of travel of the vehicle. For example, the sensor can include one or more than one camera that captures still images in the front (e.g., in the direction of travel) and the rear (e.g., opposite the direction of travel) of the vehicle. Optionally, the sensor may include a radar system that sends and receives pulses reflected off of an object in order to detect a presence and/or location of an object in an area outside of the vehicle system. Optionally, the sensor may be an alternative sensing system that obtains data of an area outside of the vehicle.

The vehicle control system may include or otherwise be connected with a positive control device 218. The positive control device system can include or otherwise represent various software and/or hardware circuitry that includes and/or is connected with one or more processors and/or communication device devices. The communication devices can receive signals from wayside devices and/or a dispatch control system indicating conditions of routes upon which the vehicle system may travel, locations of other and different vehicles, movement directions of those vehicles, occupancies of routes, speeds of those vehicles, etc. For example, the signals may indicate that a movement authority has been issued, an upcoming segment of a route is under repair, is occupied, contains an obstacle or is otherwise unavailable for travel. As another example, the communication device(s) may communicate with other vehicles to obtain and/or provide information on the conditions of previous or upcoming portions of the route (e.g., weather, presence of damage or another vehicle, etc.). The positive control device can generate a command for navigating the vehicle based at least in part on the received signals. For example, the positive control device system can generate a positive control command that is implemented by the controller to stop or slow (e.g., to satisfying a maximum speed threshold) movement of the vehicle system based at least in part on the received signals. A suitable positive control device is the I-ETMS Positive Train Control system available from Wabtec Corporation.

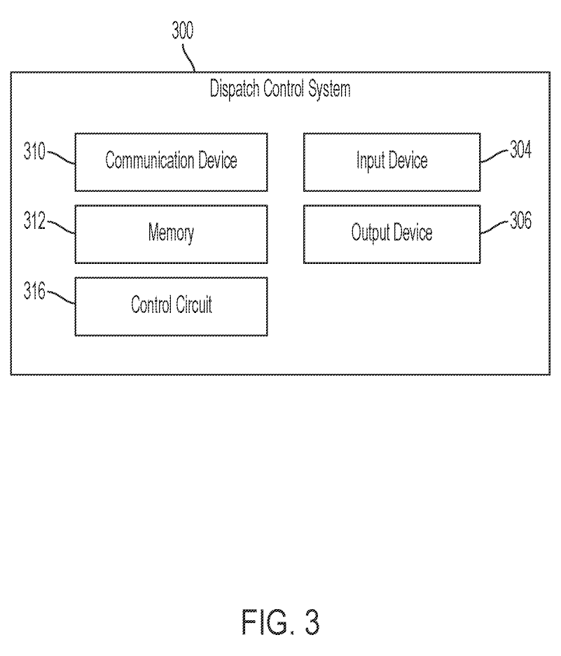

FIG. 3 is a schematic illustration of one embodiment of dispatch control system 300. The dispatch control system includes a communication device 310, a memory 312, an input device 304, an output device 306, and a control circuit 316. The input device may include one or more than one device such as a touchscreen, keyboard, electronic mouse, microphone, button, and/or other input devices. The output device can include one or more than one device such as a display screen (e.g., touchscreen or other screen), a speaker, a printer, and/or other output devices. The communication device can include or represent hardware and/or software that is used to communicate the vehicle control system of one or more vehicle via the network. For example, the communication device may include a transceiver and associated circuitry for wirelessly communicating linking messages, command messages, reply messages, repeat messages, or the like. Via the communication device, dispatch control system may receive information related to the current and/or planned movement and operation of vehicles. The dispatch control system, via the output device, can present statuses of the vehicle(s) based on the received information.

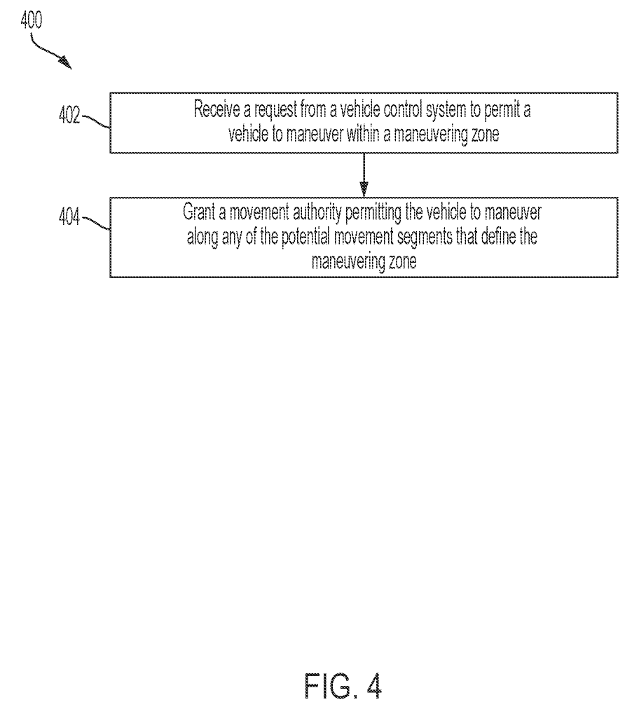

FIG. 4 is a flow diagram of a method for managing vehicle movement within a vehicular travel area, according to one embodiment. The method may be executed, at least in part, by a control circuit of a dispatch control system. According to the method, the control circuit receives 402 a request from a vehicle control system to permit a vehicle to maneuver within a maneuvering zone. The maneuvering zone may be defined by at least two potential movement segments. The at least two potential movement segments are separate movement segments. The control circuit grants 404 a movement authority permitting the vehicle to maneuver along any of the potential movement segments that define the maneuvering zone.

According to one embodiment of the method, the maneuvering zone is within a vehicular travel area. the control circuit withholds access of other vehicles that are in the vehicular travel area to the maneuvering zone based at least in part on granting the movement authority permitting the vehicle to maneuver along any of the potential movement segments that define the maneuvering zone.

According to one embodiment of the method, the control circuit revokes the movement authority to maneuver within the maneuvering zone.

According to one embodiment of the method, the control circuit detects a conflict related to maneuvering the vehicle within the maneuvering zone and a planned route of at least one of the other vehicles within the vehicular travel area.

According to one embodiment of the method, the control circuit receives an indication from the vehicle that the movement authority is no longer requested or a desired vehicle movement is complete.

According to one embodiment of the method, the control circuit assesses position and movement data corresponding to other vehicles within the vehicular travel area. The control circuit may detect a conflict related to maneuvering the vehicle within the maneuvering zone and a planned route of at least one of the other vehicles based at least in part on the position and movement data corresponding to the other vehicles within the vehicular travel area. The control circuit may revoke the movement authority to maneuver within the maneuvering zone based at least in part on the position and movement data corresponding to the other vehicles within the vehicular travel area.

According to one embodiment of the method, the control circuit determines a list of available routes within the maneuvering zone. The control circuit may transmit the list of available routes to the vehicle control system. The list of available routes may include a first route comprising a first potential movement segment and a second route comprising a second potential movement segment.

According to one embodiment of the method, based at least in part on granting the vehicle the movement authority, and thereby to allowing the vehicle to move within the maneuvering zone, the control circuit adjusts a control device to enable the vehicle to travel along a selected route from the list of available routes defining the maneuvering zone. The control device may prevent the other vehicles from traveling within the maneuverings zone based at least in part on the granting the vehicle the movement to the vehicle. The control device may include a positive control device. The control device may include a track switch, a signal, or a track switch and a signal.

According to one embodiment of the method, the control circuit modifies the maneuvering zone to define a different portion of the vehicular travel area based at least in part on the vehicle traveling along a selected route.

The terms "control circuit" and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features can be stored in various types of memory. Suitable memory may include dynamic random-access memory (DRAM), flash memory, and/or cache. These instructions can be distributed over a network or via other computer-readable media. The term "non-transitory computer-readable medium" refers to any physical medium capable of storing or transmitting instructions or information that can be read by a machine. Examples of suitable media include RAM, ROM, EPROM, EEPROM, magnetic or optical media, flash memory, or even propagated signals such as carrier waves or infrared signals.

In some embodiments, the control circuit can utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model or a good-enough model may be selected, and the control circuit can execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. raw data gathered by these sensors may feed into the control circuit, which in turn can respond to the input. The responses may include dynamically adjusting vehicle operations in response to real-time or near real-time changes in the environment or vehicle parameters; and, processing the data for further analysis. In certain embodiments, sensors may utilize various types of communication protocols (e.g., Bluetooth, ZigBee, Wi-Fi, or cellular networks) to share data with control systems both within the vehicle and to external data processing centers

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as "processing," "computing," "calculating," or "determining" refer to operations carried out by the control circuit, which may include computing systems or electronic devices that manipulate data represented as physical (electronic) quantities within memory or registers. One or more components may be described as "configured to," "configurable to," "operable/operative to," "adapted/adaptable to," or similar terms. Unless explicitly stated, these terms encompass components in both active and inactive states. Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A system comprising a control circuit configured to:
receive a request from a vehicle control system for a movement authority to maneuver a vehicle within a maneuvering zone that defines a portion of a vehicular travel area and comprises two or more potential movement segments; and
grant the vehicle the movement authority to maneuver within the maneuvering zone.

2. The system of claim 1, wherein the control circuit is further configured to withhold access of other vehicles that are in the vehicular travel area to the maneuvering zone based at least in part on granting the vehicle the movement authority to maneuver within the maneuvering zone.

3. The system of claim 2, wherein the control circuit is configured to revoke the movement authority to maneuver within the maneuvering zone.

4. The system of claim 3, wherein the control circuit is configured to detect a conflict related to maneuvering the vehicle within the maneuvering zone and a planned route of at least one of the other vehicles within the vehicular travel area.

5. The system of claim 3, wherein the control circuit is configured to receive an indication from the vehicle control system that the movement authority is no longer requested or a desired vehicle movement is complete.

6. The system of claim 2, wherein the control circuit is further configured to assess position and movement data corresponding to the other vehicles within the vehicular travel area.

7. The system of claim 2, wherein the control circuit is further configured to:
determine a list of available routes defining the maneuvering zone; and
transmit the list of available routes to the vehicle control system.

8. The system of claim 7, wherein the list of available routes comprises a first route comprising a first potential movement segment and a second route comprising a second potential movement segment.

9. The system of claim 7, wherein the control circuit is configured to, based at least in part on granting the vehicle the movement authority, cause a control device to enable the vehicle to travel along a selected route from the list of available routes defining the maneuvering zone.

10. The system of claim 9, wherein the control circuit is configured to modify the maneuvering zone to define a different portion of the vehicular travel area based at least in part on the vehicle traveling along the selected route.

11. The system of claim 9, wherein the control device is part of the vehicle control system, and comprises a positive control device.

12. The system of claim 9, wherein the vehicle is a rail vehicle, the vehicular travel area comprises a plurality of tracks traversable by the rail vehicle, and the control device comprises a track switch, a signal, or a track switch and a signal.

13. A vehicle control system comprising a control circuit configured to:
request, from a dispatch control system, a movement authority to maneuver a vehicle within a maneuvering zone;
receive the movement authority from the dispatch control system; and
move the vehicle along a selected route within the maneuvering zone.

14. The vehicle control system of claim 13, wherein the control circuit is configured to receive an operator input identifying potential routes from a list of available routes and to define the maneuvering zone.

15. The vehicle control system of claim 14, wherein the list of available routes comprises a first route comprising a first potential movement segment and a second route comprising a second potential movement segment.

16. The vehicle control system of claim 13, wherein the control circuit is configured to cause an adjustment of a control device to enable the vehicle to travel along the selected route.

17. The vehicle control system of claim 16, wherein the control device comprises at least one a signal, or a switch, or a combination thereof.

18. The vehicle control system of claim 16, further comprising the control device, wherein the control device comprises a positive control device.

19. The vehicle control system of claim 13, wherein the control circuit configured is to transmit an indication to the dispatch control system that the movement authority is no longer requested or a desired vehicle movement is complete.

20. A method, comprising:
receiving, by a dispatch control system, a request from a vehicle control system to permit a vehicle to maneuver within a maneuvering zone, wherein the maneuvering zone is defined by at least two separate movement segments; and
granting, by the dispatch control system, a movement authority permitting the vehicle for unrestricted maneuvering along any of the separate movement segments that define the maneuvering zone.
